(19) United States
(12) Patent Application Publication
(10) Pub. No.: US 2003/0129497 A1
(43) Pub. Date: Jul. 10, 2003

(54) Anode for a secondary battery

(75) Inventors: Hironori Yamamoto, Tokyo (JP); Mitsuhiro Mori, Tokyo (JP); Jiro Iriyama, Tokyo (JP); Kouji Utsugi, Tokyo (JP); Tamaki Miura, Tokyo (JP); Yutaka Bannai, Tokyo (JP); Mariko Miyachi, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/232,579

(22) Filed: Sep. 3, 2002

(30) Foreign Application Priority Data
Sep. 3, 2001 (JP) 2001-265924

(51) Int. Cl. H01M 4/40; H01M 2/16; H01M 4/48

(52) U.S. Cl. 429/246; 429/231.95; 429/218.1

(57) ABSTRACT

An anode for use in a non-aqueous-electrolyte secondary battery includes an active material film for occluding and releasing lithium ions, and an amorphous carbon film or a diamond-like carbon film covering the active material film for suppressing growth of dendrite and degradation of the anode, thereby achieving improved cycle lifetime of the secondary battery.

### BACKGROUND OF THE INVENTION

(a) Field of the Invention

The present invention relates to an anode for a secondary battery and, more particularly, to a non-aqueous-electrolyte secondary battery including an anode made of metallic lithium, an alloy or oxide thereof, or having a carbon-based material as a main component thereof.

(b) Description of the Related Art

Along with progress of wider use of mobile terminals such as cellular phone or notebook personal computer, the importance of batteries for use as the power sources of these mobile terminals is highlighted. These batteries are requested to have smaller dimensions, smaller weight and higher current-storage capacity, as well as higher performance wherein the batteries are not degraded irrespective of iterated charge and discharge cycles thereof.

Metallic lithium has been often used as the material of the anode in the secondary battery in view of higher energy density and smaller weight of the metallic lithium. However, the anode made of metallic lithium suffers from a problemin that dendrite is precipitated on the surface of the metallic lithium and peeled-off from the collector along with the charge and discharge cycles. The dendrite may penetrate the separator of the battery to cause problems such as a short-circuit failure within the battery, and reduction of the lifetime and degradation in the cycle characteristics of the battery.

Patent Publication JP-A-6-223820 describes a solution of the above problems in a lithium secondary battery, by depositing a polymer film having a lithium-ion conductivity on the lithium electrode by a plasma-enhanced CVD technique. The resultant lithium secondary battery has an electromotive force comparable to that of the metallic lithium and has a longer cycle lifetime, i.e., lifetime with iterated charge and discharge cycles of the battery.

Patent Publication JP-A-6-283157 describes prevention of generation or growth of dendrite by providing a film made of polymer, fluororesin or glass-like metallic oxide, which allows the ions involved in the battery reaction to pass therethrough.

However, those conventional lithium electrodes have the problems as detailed below.

First, it is difficult to prevent the growth of the dendrite involved with the charge and discharge cycles. This is because the surface of the lithium electrode reacts with the electrolyte during the charge and discharge cycles to increase the activity of the surface and eventually allow the dendrite to grow thereon, even if the polymer film or a film having a high-molecule structure (hereinafter, referred to as simply polymer film) allows the ions to pass therethrough.

Second, it is difficult to prevent the damage of the polymer film during the charge and discharge cycles because, although the polymer film allows the ions to pass therethrough, the polymer film is damaged in its film structure due to iterative volume expansion and shrinkage of the anode during the charge and discharge cycles whereby the functions of the polymer film is lost.

Another conventional technique uses an anode including a carbon-based material as a main component thereof.

Patent Publication JP-A-5-275076 describes a carbon-based material for use in an anode of a lithium secondary battery, wherein the surface of the carbon-based material is covered with an amorphous carbon film. In this technique, it is recited in the publication that the lithium ions are intercalated between the carbon layers of the amorphous carbon film in a solvated state, thereby preventing the carbon layers from being damaged to suppress the degradation in the cycle characteristics of the secondary battery.

Patent Publication JP-A-8-153514 describes an anode in a non-aqueous-electrolyte secondary battery, the anode having a laminated structure including graphite layer and an amorphous carbon layer for protecting the graphite layer. Although the anode has a large lithium-occluding capacity, the anode includes the graphite layer having a large lithium-occluding capacity and an undesirable property of susceptibility to degradation caused by the electrolyte, and the amorphous carbon layer having an undesirable small lithium-occluding capacity and a property of non-susceptibility to degradation caused by electrolyte. It is recited in this publication that the anode has both the merits of the graphite and the amorphous carbon, and the resultant secondary battery has a higher current-storage capacity, lower self-discharge rate and excellent characteristics in a lower temperature range.

The conventional techniques having anodes using the carbon-based materials as described above, however, do not have a sufficient level of the battery capacity (or current-storage capacity) and sufficient cycle characteristics.

### SUMMARY OF THE INVENTION

In view of the above problems in the conventional techniques, the present invention provides an anode for use in a secondary battery, which is capable of operating with a higher performance while suppressing the change of the potential difference between the cathode and the anode after iterated charge and discharge cycles, by suppressing generation of the dendrite and degradation of the anode caused by the electrolyte.

The present invention provides, in a first aspect thereof, an anode for use in a secondary battery, including an active material for occluding and releasing lithium ions, and a diamond-like carbon (DLC) film covering at least a portion of a surface of the active material.

The DLC film as used in the present invention is different from an ordinary amorphous carbon film in the property thereof and may have one of the properties, as observed by Raman spectroscopy, that:

(i) the Raman spectrum of the DLC coat has at least one peak between the wave numbers 1500 cm⁻¹ and 1630 cm⁻¹, the at least one peak having a FWHM (full width at half maximum) value of 150 cm⁻¹ or above;

(ii) the Raman spectrum of the DLC film has a single peak between the wave numbers 800 cm⁻¹ and 1900 cm⁻¹; and

(iii) the Raman spectrum of the DLC film has at least one peak between wave numbers 1250 cm⁻¹ and 1350 cm⁻¹, and another at lest one peak between wave numbers 1400 cm¹ and 1500 cm⁻¹.

In one embodiment of the present invention, the anode includes an active material including Si and/or Sn. More preferably, the anode may include an active material which includes at least one material selected from the group consisting of Si, Sn and an oxide of Si or Sn.

In another embodiment, the anode includes an active material including Li, LiAl, LiSi and/or LiSn.

In a preferred embodiment of the present invention, the anode includes an active material film including at least one layer selected from the group consisting of: a layer including carbon as a main component thereof; a layer including metallic Si or metallic Sn; a layer including SiOₓ (0<x≦2) or SnO_{y} (0<y≦2); and a layer including Li, LiAl, LiSi or LiSn, and a diamond-like carbon film covering the active material film.

The active material film may be a film made of a carbon material wherein lithium-occluding particles are dispersed.

The present invention also provides, in a second aspect thereof, anode for use in a secondary battery, including an active material for occluding and releasing lithium ions, the active material including powdery particles each covered by an amorphous carbon film.

The structure of the powdery particles covered each by the amorphous carbon film effectively prevents generation of dendrite as well as degradation of the active material which may be caused by ingress of the electrolyte.

The lithium-occluding material may include Si and/or Sn, and preferably includes at least one material selected from the group consisting of Si, Sn and an oxide of Si or Sn. The lithium occluding material may be Li, LiAl, LiSi or LiSn instead.

The present invention also provides, in a third aspect thereof, an anode for use in a secondary battery including an active material film including Li, Si and/or Sn, and an amorphous carbon film covering at least a portion of a surface of the active material.

In the third aspect, the active material film preferably includes at least one layer selected from the group consisting of: a layer including metallic Si or metallic Sn; a layer including SiOₓ (0<x≦2) or SnO_{y} (0<y≦2); and a layer including Li, LiAl, LiSi or LiSn.

The active material film may be such that lithium-occluding particles are dispersed in a carbon-based material film.

The amorphous carbon film may be a diamond-like carbon (DLC) film such as described before.

The present invention also provides, in a fourth aspect thereof, a secondary battery including one of the anodes of the present invention, a cathode capable of occluding and releasing lithium ions, and an electrolyte disposed between the anode and the cathode for transferring the lithium ions therethrough.

In the secondary battery of the present invention, the amorphous carbon film or the diamond-like carbon (DLC) film may preferably cover the anode on the entire surface of the active is material film; however, may cover a portion of the surface of the active material film with the remaining portion being exposed.

In general, the DLC film and the amorphous carbon film are chemically stable and scarcely react with the electrolyte, thereby suppressing the growth of dendrite thereon. In addition, since these films have strong chemical bonds, the structures of these films are scarcely changed irrespective of volume expansion and shrinkage of the anode associated with the charge and discharge operation. Further, since the film density in these films can be controlled by selecting the deposition technique, the ion conductivity can be controlled. Further, since these films have properties similar to those of carbon generally used in the lithium-ion secondary battery, the potential difference between the cathode and the anode is not affected thereby.

The DLC film and the amorphous carbon film are basically carbon that is most used as the material for the lithium-ion secondary battery, which fact means that a desirable affinity resides between Li and carbon. In addition, there arises substantially no problem in the contact between these films and the carbon-based anode because these films are basically carbons. Thus, the DLC film or amorphous carbon film covering the anode suppresses the degradation of the anode caused by the growth of dendrite and the electrolyte, thereby increasing the cycle lifetime of the secondary battery.

It is preferable that the amorphous carbon film of the anode according to the present invention be a DLC film, which has excellent chemical and mechanical stability when used as an overcoat material for the carbon-based anode.

### BRIEF DESCRIPTION OF THE DRAWINGS

FIG. 1 is a sectional view of an anode according to a first embodiment of the present invention and used in a non-aqueous-electrolyte secondary battery.

FIG. 2 is a sectional view of an anode manufactured as a first comparative example.

FIG. 3 is a graph showing the cycle characteristics of the first samples of the first embodiment and the first comparative examples.

FIG. 4 is a graph showing the cycle characteristics of second samples of the first embodiment and second comparative examples.

FIG. 5A is a graph showing the cycle characteristics of third samples of the first embodiment and third comparative examples, and FIG. 5B is a graph showing the cycle characteristics of fourth samples of the first embodiment and fourth comparative examples.

FIG. 6 is a sectional view of an anode manufactured as a sixth sample of the first embodiment.

FIG. 7 is a sectional view of an anode manufactured as a sixth comparative example.

FIG. 8 is a sectional view of an anode manufactured as a is seventh sample of the first embodiment.

FIG. 9 is a sectional view of an anode manufactured as a seventh comparative example.

FIG. 10 is a sectional view of an anode manufactured as an eighth sample of the first embodiment.

FIG. 11 is a sectional view of an anode manufactured as an eighth comparative example.

FIG. 12 is a sectional view of an anode manufacture as a ninth sample of the first embodiment.

FIG. 13 is a sectional view of an anode manufactured as a ninth comparative example.

FIG. 14 is a Raman spectrum of an overcoat of an anode manufactured as a tenth sample of the first embodiment.

FIG. 15 is a Raman spectrum of the overcoat of the anode of the tenth sample of the present invention.

FIG. 16 is a Raman spectrum of the overcoat of the anode of the tenth sample.

FIG. 17 is a Raman spectrum of the overcoat of an anode manufactured as a tenth comparative example.

FIG. 18 is a sectional view of an anode according to a second embodiment of the present invention.

FIG. 19 is a sectional view of an anode manufactured as a fifteenth sample of the present invention for the second embodiment.

FIG. 20 is a sectional view of the anode manufactured as sixteenth sample of the present invention for the present invention.

FIG. 21 is a sectional view of a secondary battery according to a third embodiment of the present invention,

### PREFERRED EMBODIMENTS OF THE INVENTION

Now, the present invention is more specifically described with reference to specified embodiments thereof.

The term “amorphous carbon” as used in this text means carbon having an amorphous structure, and includes hard carbon, glass-like carbon and PLC.

The DLC is comprised of carbon element similarly to diamond and graphite, and has an amorphous structure. The chemical bonds between carbon atoms in the DLC include sp³ bonds of the diamond structure and sp² bonds of the graphite structure, whereby the DLC has no regular, fixed crystal structure as viewed along the long dimensions thereof to assume an amorphous structure. The characteristics of the DLC film are similar to those of diamond as will be supposed from the name thereof.

The DLC film may be preferably formed by the processes as exemplified hereinafter.

CVD

The DLC film may be formed by a CVD technique, wherein the reactive gas introduced in a chamber is ionized to assume a plasma state, which generates therein active radicals and ions to proceed chemical reaction at a relatively lower temperature to deposit a thin film on a subject or substrate. The gas pressure used here is 1 to 100Pa, and the plasma is generated therein by discharge using DC, AC, RF (radio frequency), microwave, ECR (electron cyclotron resonance) or helicon wave source.

Either CH₄, C₂H₂ or CO₂ gas is used as the source gas, which is mixed with hydrogen, argon, and oxygen.

A RF-plasma-enhanced CVD technique uses a RF power source oscillating at a frequency of 13.56MHz. The source gas is obtained, for example, by mixing methane and hydrogen at a ratio of 9:1 to 1:9, with the RF power being set at 10 to 1000 watts. The gap between the plasma electrode and the substrate (or anode) is set at 5 to 20 cm, the diameter of the plasma electrode being set at 3 to 12 inches.

An ECR-CVD technique uses a source gas obtained by mixing methane and hydrogen at a ratio of 9:1 to 1:9, ionizing the source gas to assume a plasma state by using a 2.45GHz microwave, thereby depositing the DLC film on the anode.

Sputtering

The DLC film may be deposited by sputtering, wherein graphite is used as the target material, the surface of which is sputtered by argon plasma or argon ions. The argon plasma is generated using a 2.45GHz microwave power source, and irradiates the surface of the target with plasma or an ion beam for sputtering. The acceleration energy for the ion beam is preferably 2 to 10 keV, and the graphite particles generated thereby from the target impinge upon the anode to form a DLC film on the anode. The anode may be irradiated by hydrogen plasma or a hydrogen ion beam at this stage to improve the hardness of the resultant DLC film.

Evaporation

The DLC film may be deposited by an evaporation technique, wherein graphite is used as the source material, the surface of which is irradiated by an electron beam for fusion and evaporation of the source material to deposit a DLC film on the anode. This process uses a higher temperature compared to the CVD technique or sputtering technique due to the fusion of the source material. The gap between the source material and the anode is 10 to 60 cm, with the power of the electron beam being set at 1 to 12 kW. A minute amount of hydrogen may be added in the chamber during the evaporation,

A material for the cathode used in the secondary battery of the present invention may be prepared by: dispersing-mixing a composite oxide, LiMO₂ (where M is at least one of transition metals) such as LiₓCoO₂, LiₓNiO₂, LiₓMn₂O₄, LiₓMnO₃, LiₓNi_{y}C_{1-y}O₂, with a solvent such as N-methyl-2-pyrolidone (NMP), while using a conductive material such as carbon black and a binder such as polyvinylidene fluoride (PVDF); and coating the substrate such as an aluminum foil with the resultant mixture.

The secondary battery of the present invention may be manufactured by laminating an anode assembly and a cathode assembly, with a porous film sandwiched therebetween as a separator, in a dry air ambient or inert gas ambient. The porous film may be made of polyolefine, such as polypropylene or polyethylene, or fluororesin. The laminated structure may be received in a battery can as it is or after winding thereof, or may be encapsulated by a flexible film container made of, for example, a laminate of synthetic resin film and a metallic foil.

The electrolyte (electrolytic solution) may include a non-proton organic solvent or a mixture of a plurality of non-proton organic solvents, wherein a lithium salt soluble to the non-proton organic solvent is dissolved. Examples of the non-proton organic solvent include: ring carbonate group such as propylene carbonate (PC), ethylene carbonate (EC), butylene carbonate and vinylene carbonate (VC); chain carbonate group such as dimethyl carbonate (DMC), diethyl carbonate (DEC), ethylmethyl carbonate (EMC) and dipropyl carbonate (DPC); aliphatic carboxylic acid ester group such as methyl formate, methyl acetate and ethyl propionate; γ-lactone group such as γ-butylolactone; chain ether group such as 1,2-ethoxyethane (DEE) and ethoxymethoxyethane (EME); ring ether group such as tetrahydrofurane and 2-methyltetrahydrofurane; and other non-proton organic solvents such as dimethylsulfoxide, 1,3-dioxolane, formaldehyde, acetamide, dimethylformaldehyde, dioxolane, acetonitrile, proplylnitorile, nitromethane, ethylmonogreim, phosphoric triester, trimethoxymethane, dioxolane derivatives, sulfolane, methylsulfolane, 1,3-dimethyl-2-imidazolidinone, 3-methyl-2-oxozolidinone, propylene carbonate derivatives, tetrahydrofurane derivatives, ethylether, 1,3-propanesultone, anisole and N-methylpyrolidone.

Examples of the lithium salt include LiPF₆, LiAsF₆, LiAlCl₄, LiClO₄, LiBF₄, LiSbF₆, LiCF₃SO₃, LiCF₃CO₂, Li(CF₃SO₂)₂, LiN(CF₃SO₂)₂, Li₁₀Cl₁₀; lithium low-grade aliphatic carboxynate, lithium chloroborane, lithium quatery-phenylbornate, LiBr, LiI, LiSCN, LiCl, and imide group. The electrolytic solution may be replaced by polymer electrolyte.

FIG. 21 shows a secondary battery according to an embodiment of the present invention, wherein the secondary battery is shown as enlarged in the thickness direction of an anode collector 34. The cathode 37 includes a cathode collector 31 and an active material film 32 formed thereon and including a cathode active material. The anode 38 includes an anode collector 34 and an active material film 33 formed thereon and including an anode active material. Both the cathode 37 and the anode 38 oppose each other, with an electrolyte 35, i.e., aqueous electrolytic solution and a porous separator 36 being disposed therebetween. The porous separator 36 extends parallel to the active material film 33.

The secondary battery according to the embodiment of the present invention may have a shape of cylinder, hexahedron, coin etc., but not limited thereto.

Now, the anode of the present invention is more specifically described with reference to specific embodiments thereof, wherein a pair of active material films are deposited on both surfaces of the collector, with reference to the accompanying drawings.

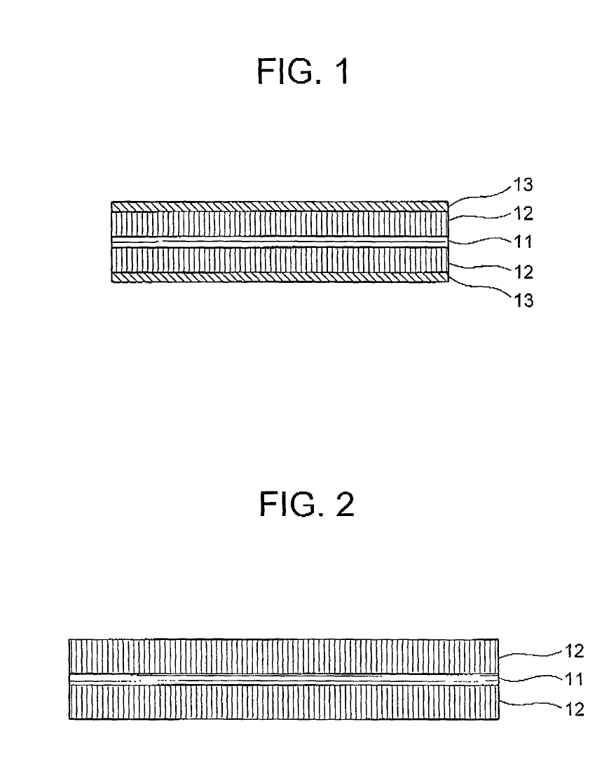

Referring to FIG. 1, an anode, fore use in a non-aqueous-electrolyte secondary battery, according to a first embodiment of the present invention includes a collector 11, active material films (or bodies) 2 formed on both surfaces of the collector 11, and a DLC film 13 formed on each of the active material films 2. The collector 11 functions as an external electrode for extracting current from or introducing current into the anode during discharging and charging the same. The collector 11 may be formed as a metallic foil made of aluminum, copper, stainless steel, gold, tungsten, molybdenum or titanium, for example. The active material film 12 functions for occluding or releasing lithium during charge and discharge of the battery. Examples of the material for the active material film 12 for the anode include lithium metal, lithium alloy, lithium-occluding metal, lithium-occluding alloy, metallic oxide, graphite, fullerene, carbon nanotube, and a mixture or combination thereof. The DLC film 13 is deposited on the active material film 12 by CVD, evaporation or sputtering. The DLC film 13 may be replaced by an amorphous carbon film.

The anode of FIG. 1 for use in a non-aqueous-electrolyte secondary battery is manufactured by the process as described hereinafter. The process begins with a collector 11 made of copper foil, on which an active material film 12 for anode is deposited. Finally, the DLC film (or amorphous carbon film) 13 is deposited thereon by sputtering, CVD, or evaporation,

In a charge operation of the non-aqueous-electrolyte secondary battery, the anode receives lithium ions from the cathode via an electrolyte. In this step, the lithium ions first pass the DLC film 13, and then are occluded by the active material film 12. The charge operation is finished when substantially all of the lithium ions are occluded. During the charge operation, the active material film 12 expands to increase its volume due to the occlusion. On the other hand, during a discharge operation, the active material film 12 releases the lithium ion thus occluded during the charge operation, and shrinks to reduce its volume, The s lithium ions released by the active material film 12 passes the DLC film 13 to move toward the cathode via the electrolyte.

Some of the lithium ions stay within the DLC film 13 during the charge operation, and the some of the lithium ions move toward the cathode during the next discharge operation. In these charge and discharge cycle, the DLC film 13, which is chemically stable and has a high degree of hardness, suppresses growth of dendrite or degradation of the materials for the anode caused by the electrolyte. In addition, the DLC film 13 is scarcely damaged by the cubic expansion and shrinkage of the active material film 12, and exists on the active material film 12 with excellent stability.

Variety of samples of the anode of the first embodiment shown in FIG. 1 as well as comparative examples shown in FIG. 2 are used for manufacturing secondary batteries and subjected to cycle tests for measurements of the cycle characteristics of the secondary batteries. The comparative example shown in FIG. 2 is similar to the first embodiment except that the comparative example has no DLC film on the active material film 12. Other samples of modifications of the present embodiment and other embodiments, which will be described later, and corresponding comparative examples were also used for manufacturing secondary batteries and subjected to similar cycle tests.

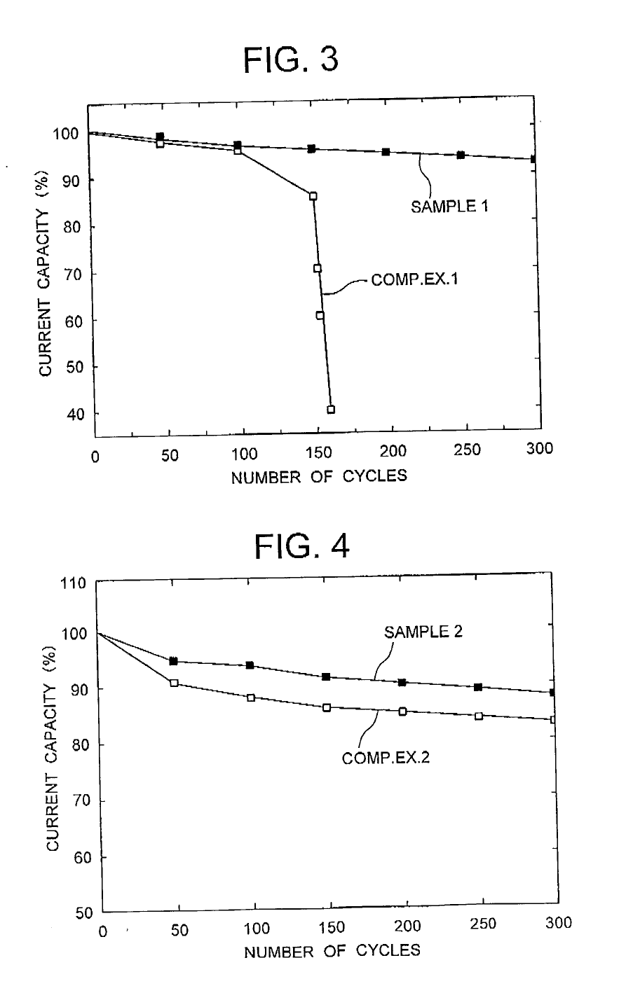

Each of the first samples of the anode of the first embodiment had a collector 11 made of 10-μm-thick copper foil, an active material film 12 made of 50-μm-thick lithium metal, and a 40-nm-thick DLC film 13. The first samples were manufactured by vacuum filming techniques including CVD, evaporation and sputtering. The cycle characteristics of the secondary batteries having the anodes of the first samples were measured at a current density of 10 mA/cm² during the charge and discharge operations, The results of the cycle tests are shown in FIG. 3 in terms of the current-storage capacity (%) of the secondary battery, wherein the ratio of the current-storage capacity of the secondary battery after each specified number of charge and discharge cycles to the initial current-storage capacity is plotted against the each specified number of cycles.

The anodes of the first comparative examples are similar to the first samples, except that each first comparative example had no DLC film formed on the active material film 12. The secondary batteries having the anodes of the first comparative examples were subjected to similar measurements, the results are also shown in FIG. 3 for comparison.

As will be understood from FIG. 3, it was confirmed that the cycle lifetimes of the anodes of the first samples of the first embodiment were as large as above double the cycle lifetime (about 150 cycles) of the first comparative examples.

Each of the second samples of the first embodiment had a collector 11 made of 10-μm-thick copper foil, an active material film 12 made of 100-μm-thick graphite, and a 10-nm-thick DLC film 13 deposited by sputtering. The active material in the active material film 12 included natural graphite, artificial graphite or hard carbon as a main component thereof, and had a grain size of 10 to 50 μm. The current density during the charge and discharge cycles was maintained at 10 mA/cm², similarly to the case of the first samples. FIG. 4 shows the results of the measurements of the second samples, similarly to FIG. 3. The second comparative examples were similar to the second samples except that each second comparative example had no DLC film.

As understood from FIG. 4, the second samples having the DLC films improved the characteristics of the secondary butteries by about 5% over the second comparative examples in terms of the current-storage capacity (%), wherein the current-storage capacity of each secondary battery is measured after 300 cycles of charge and discharge operation.

Table 1 shows the results of the comparison of the second samples against the second comparative examples in the current-storage capacity after 300 cycles for each case of the active materials being used for the anode.

TABLE 1

| Active material | Artificial graphite | Natural graphite | Hard carbon |
|---|---|---|---|
| Sample 2 | 88% | 87% | 86% |
| Comp. Ex. 2 | 83% | 83% | 81% |

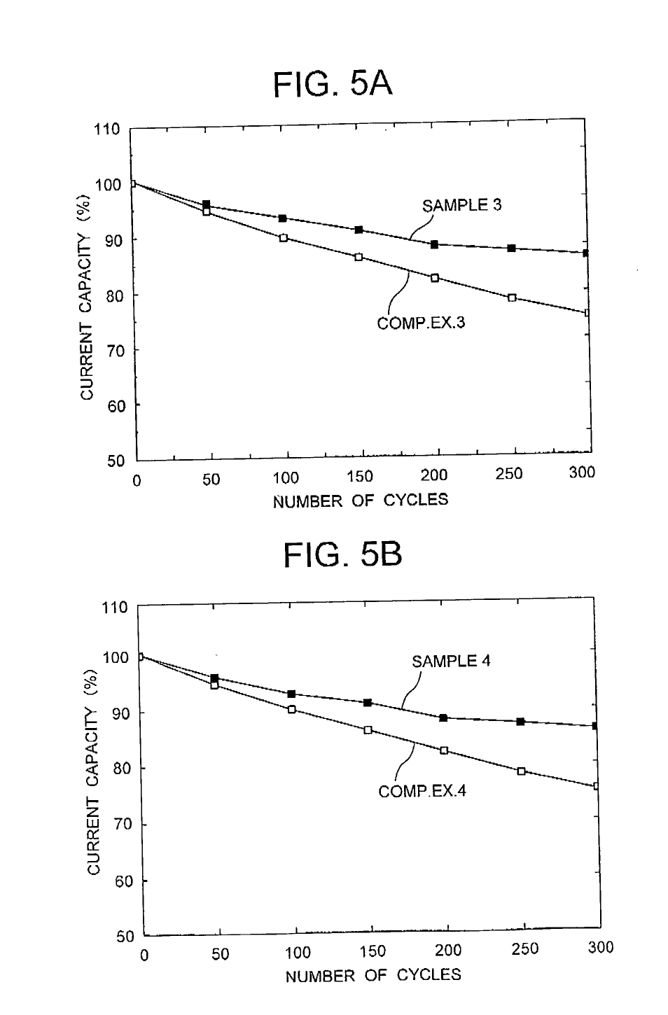

Each of the third samples of the anode of the first embodiment had a collector 11 made of 15-μm-thick copper foil, an active material film 12 made of 15-μm-thick lithium-occluding metal, i.e., Si, Sn or Al, and a 20-nm-thick DLC film 13 deposited by evaporation. The third comparative examples are similar to the third samples except that the third comparative examples had no DLC film. Cycle tests similar to those for the first and second samples were conducted to the third samples and the third comparative examples. Table 2 shows the results after 300 cycles similarly to Table 1. FIG. 5 also shows the results of the cycle tests of the third samples and the third comparative examples, wherein Si is used as the active material.

TABLE 2

| Active material | Si | Sn | Al |
|---|---|---|---|
| Sample 3 | 86% | 84% | 83% |
| Comp. Ex. 3 | 75% | 75% | 73% |

As understood from FIG. 5 and Table 2, the third samples having the DLC films improved the current-storage capacity by about 10% over the third comparative examples in terms of current-storage capacity after 300 cycles.

Each of the fourth samples of the anode of the first embodiment had a collector 11 made of 15-μm-thick copper foil, an active material film 12 made of 10-μm-thick lithium-occluding metal, i.e., a LiAl, LiSi or LiSn alloy, and a 30-nm-thick DLC film 13 deposited by evaporation. The fourth comparative examples are similar to the fourth samples except that the fourth comparative examples had no DLC film. Cycle tests similar to those for the first through third samples were conducted to the fourth samples and the fourth comparative examples. Table 3 shows the results of the cycle tests in terms of current-storage capacity (%) after 300 cycles similarly to Table 1. FIG. 5SA shows the results for the case of LiAl.

TABLE 3

| Active material | LiAl | LiSi | LiSn |
|---|---|---|---|
| Sample 4 | 87% | 88% | 86% |
| Comp. Ex. 4 | 72% | 72% | 74% |

As understood from Table 3, the fourth samples having the DLC films improved the characteristics of the secondary batteries by about 15% over the fourth comparative examples in terms of current-storage capacity after 300 cycles.

Each of the fifth samples of the anode of the first embodiment had a collector 11 made of 15-μm-thick copper foil, an active material film 12 made of 40-μm-thick lithium-occluding metallic oxide, i.e., SiOx or SnOx (0<x≦2), and a 20-nm-thick DLC film 13 deposited by evaporation. The fifth comparative examples are similar to the fifth samples except that the fifth comparative examples had no DLC film. Cycle tests similar to those for the first through fourth samples were conducted to the fifth samples and the fifth comparative examples. Table 4 shows the test results after 300 cycles similarly to Table 1. FIG. 5B shows the results for the case of SiOx.

TABLE 4

| Active material | SiOx (0 < x ≦ 2) | SnOx (0 < x ≦ 2) |
|---|---|---|
| Sample 5 | 85% | 84% |
| Comp. Ex. 5 | 61% | 59% |

As understood from Table 4, the fifth samples of the anode improved the characteristics of the secondary batteries by about 25% over the fifth comparative examples in terms of current-storage capacity after 300 cycles.

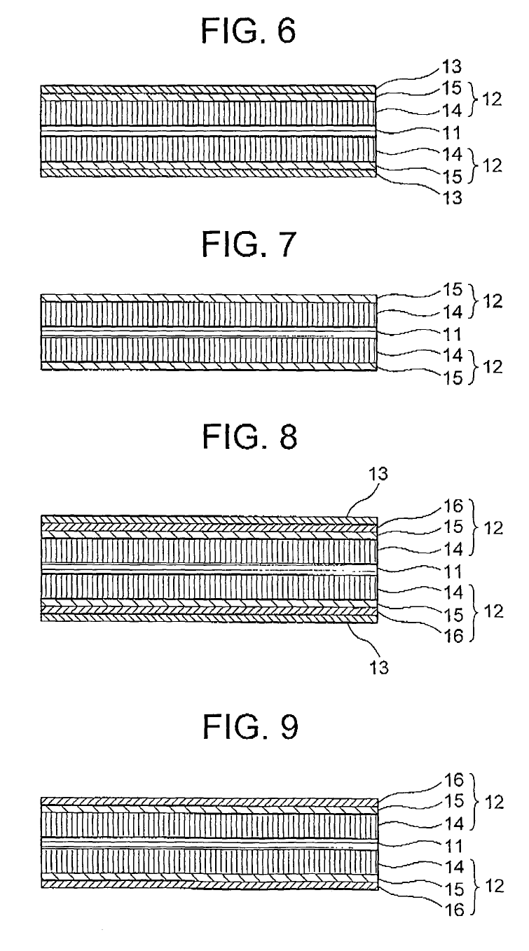

FIG. 6 shows an anode according to a first modification of the first embodiment. In this modification, each active material film 12 includes a two-layer structure including a first active material layer 14 and a second active material layer 15 formed thereon.

Each of the sixth samples of the anode according to the first modification had a collector 11 made of 10-μm-thick copper foil, an active material film 12 having a two-layer structure including 80-μm-thick graphite layer and a 5-μm-thick lithium-occluding layer formed thereon and made of lithium-occluding metal, alloy or metallic oxide, i.e., Si, Sn, Al, LiAl, LiSi, LiSn, SiOx or SnOx (0<x≦2), and a 10-nm-thick DLC film 13 deposited by CVD. In this configuration, the graphite layer constituted the first active material layer 14 in FIG. 6, whereas the lithium occluding layer constituted the second active material layer 15 in FIG. 6.

FIG. 7 shows one of the anodes manufactured as sixth comparative examples corresponding to the sixth samples. The sixth comparative examples are similar to the sixth samples except that each sixth comparative example had no DLC film. Cycle tests similar to those for the first through fifth samples were conducted to the sixth samples and the sixth comparative examples. Table 5 shows the test results after 300 cycles similarly to Table 1.

TABLE 5

| Li-occl. layer | Si | Sn | Al | LiAl | LiSi | LiSn | SiOx | SnOx |
|---|---|---|---|---|---|---|---|---|
| Sample 6 | 89% | 88% | 86% | 84% | 88% | 85% | 83% | 82% |
| Comp. Ex. 6 | 78% | 76% | 77% | 76% | 78% | 76% | 72% | 72% |

As understood from Table 5, the sixth samples of the anode improved the characteristics of the secondary batteries by about 10% over the sixth comparative examples in terms of current-storage capacity after 300 cycles,

FIG. 8 shows an anode according to a second modification of the first embodiment of the present invention. The active material film 12 has a three-layer structure including first through active material layers 14, 15 and 16.

Each of the seventh samples of the anode according to the second modification of the first embodiment had a collector 11 made of 10-μm-thick copper foil, an active material film 12 including a 90-μm-thick graphite layer, a 3-μm-thick lithium-occluding layer formed thereon and made of lithium-occluding metal, alloy or metallic oxide, i.e., Si, Sn, Al, LiAl, LiSi, LiSn, SiOx or SnOx (0<x≦2) and a 1-μm-thick lithium metal layer, and a 15-nm-thick amorphous carbon film 13 deposited on the active material film 12 by sputtering. In this configuration, the graphite layer, lithium occluding layer and the lithium layer constituted the first through third active material layers 14, 15 and 16, respectively, in FIG. 8.

FIG. 9 shows one of the anodes of seventh comparative examples manufactured corresponding to the seventh samples, The seventh comparative examples were similar to the sixth samples except that each seventh comparative example had no amorphous carbon film. Cycle tests similar to those for the first through sixth samples were conducted to the seventh samples and the seventh comparative examples. Table 6 shows the test results after 300 cycles similarly to Table 1.

TABLE 6

| Li-occl. layer | Si | Sn | Al | LiAl | LiSi | LiSn | SiOx | SnOx |
|---|---|---|---|---|---|---|---|---|
| Sample 7 | 89% | 86% | 88% | 85% | 84% | 88% | 84% | 80% |
| Comp. Ex. 7 | 78% | 77% | 76% | 76% | 76% | 78% | 72% | 72% |

As understood from Table 6, the seventh samples of the anode improved the characteristics of the secondary batteries by about 10% over the seventh sixth comparative examples in terms of current-storage capacity after 300 cycles.

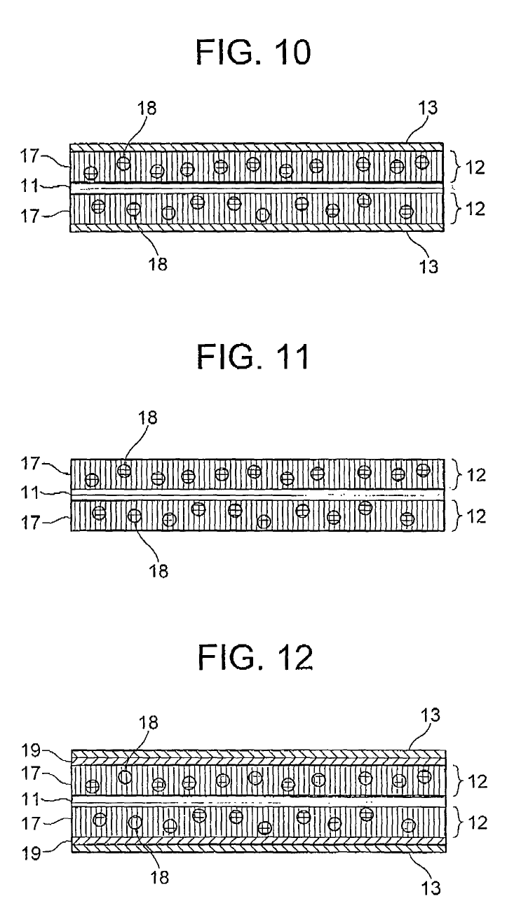

FIG. 10 shows an anode according to a third modification of the first embodiment of the present invention. Each active material film 12 includes graphite layer 17 wherein particles 18 made of lithium-occluding metal or metallic oxide are dispersed.

Each of the eighth samples of the anode according to the third modification of the first embodiment had a collector 11 made of 12-μm-thick copper foil, an active material film 12 including a 90-μm-thick graphite layer wherein lithium-occluding particles made of lithium-occluding metal or oxide, i.e., Si, Sn, Al, SiOx or SnOx (0x≦2) are dispersed, and a 18-nm-thick DLC film 13 deposited on the active material film 12 by sputtering. In this configuration, the active material includes graphite layer 17 and lithium-occluding particles 18 shown in FIG. 10.

FIG. 11 shows one of the anodes of eighth comparative examples manufactured corresponding to the eighth samples. The eight comparative examples were similar to the eighth samples except that each eighth comparative example had no DLC film. Cycle tests similar to those for the first through sixth samples were conducted to the seventh samples and the seventh comparative examples. Table 6 shows the test results of the samples after 300 cycles similarly to Table 1.

TABLE 7

| Li-occl. particles | Si | Sn | Al | SiOx | SnOx |
|---|---|---|---|---|---|
| Sample 8 | 89% | 88% | 86% | 84% | 82% |
| Comp. Ex. 8 | 78% | 73% | 71% | 70% | 66% |

As understood from Table 7, the eighth samples of the anode improved the characteristics of the secondary batteries by about 15% over the eighth sixth comparative examples in terms of current-storage capacity after 300 cycles.

FIG. 12 shows an anode according to a fourth modification of the first embodiment of the present invention. The active material film 12 has a two-layer structure including a first active material layer 17 wherein lithium-occluding particles 18 are dispersed, and a second active material layer 19 made of lithium metal.

Each of the ninth samples of the anode according to the fourth modification of the first embodiment had a collector 11 made of 12-μm-thick copper foil, an active material film 12 including a 90-μm-thick graphite layer wherein lithium-occluding particles made of lithium-occluding metal or metallic oxide, i.e., Si, Sn, SiOx or SnOx (0<x≦2) are dispersed, and a 0.8-μm-thick lithium layer, and a 18-nm-thick DLC film 13 deposited on the active material film 12 by sputtering, In this configuration the active materials include graphite and a lithium occluding material.

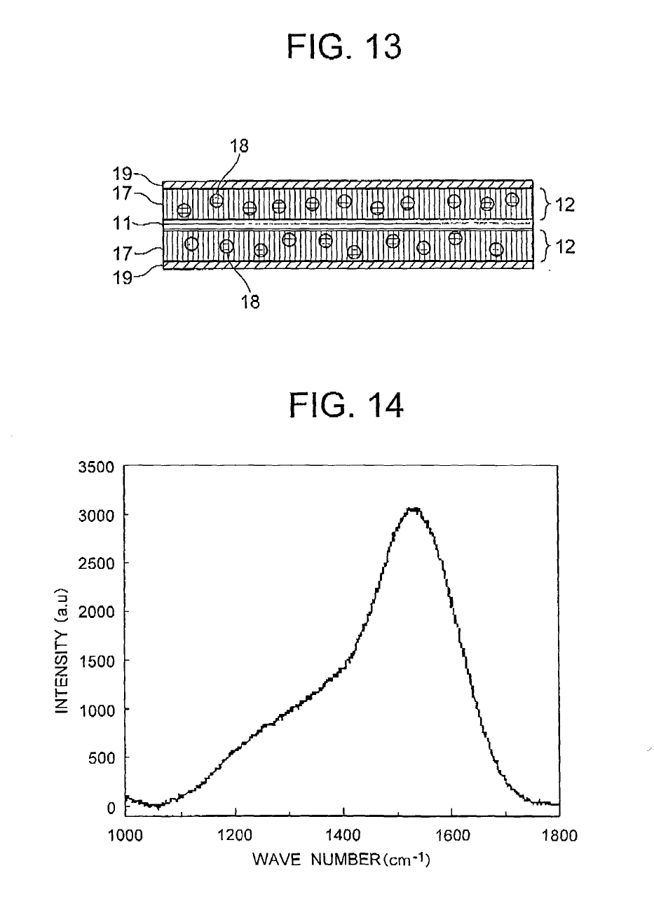

FIG. 13 shows one of the anodes of eighth comparative examples manufactured corresponding to the eighth samples.

The eighth comparative examples were similar to the eighth samples except that each eighth comparative example had no amorphous carbon film. Cycle tests similar to those for the first through seventh samples were conducted to the eighth samples and the eighth comparative examples. Table 8 shows the test results after 300 cycles similarly to Table 1.

FIG. 12 shows an anode according to a fourth modification of the first embodiment of the present invention. The active material film 12 has a two-layer structure including a first active material layer 17 wherein lithium-occluding particles 18 are dispersed, and a second active material layer 19 made of lithium metal.

Each of the ninth samples of the anode according to the fourth modification of the first embodiment had a collector 11 made of 12-μm-thick copper foil, an active material film 12 including a 90-μm-thick graphite layer wherein lithium-occluding particles made of lithium-occluding metal or metallic oxide, i.e., Si, Sn, SiOx or SnOx (0<x≦2) are dispersed, and a 0.8-μm-thick lithium layer, and a 18-nm-thick DLC film 13 deposited on the active material film 12 by sputtering, In this configuration the active materials include graphite and a lithium occluding material.

FIG. 13 shows one of the anodes of eighth comparative examples manufactured corresponding to the eighth samples.

The eighth comparative examples were similar to the eighth samples except that each eighth comparative example had no amorphous carbon film. Cycle tests similar to those for the first through seventh samples were conducted to the eighth samples and the eighth comparative examples. Table 8 shows the test results after 300 cycles similarly to Table 1.

TABLE 8

| Li-occl. layer | Si | Sn | Al | SiOx | SnOx |
|---|---|---|---|---|---|
| Sample 9 | 88% | 89% | 86% | 85% | 83% |
| Comp. Ex. 9 | 78% | 77% | 76% | 76% | 74% |

As understood from Table 8, the ninth samples of the anode improved the characteristics of the secondary batteries by about 10% over the ninth comparative examples in terms of current-storage capacity after 300 cycles.

Each of the tenth samples of the anode according to the first embodiment shown 1 had a collector 11 made of 10-μm-thick copper foil, an active material film 12 made of 50-μm-thick lithium metal, and a 40-nm-thick DLC film 13 deposited on the active material film 12. It is known that a DLC film has a variety of film properties in general depending on the method and process conditions of the deposition thereof. It is also known that graphite has, as observed by Raman spectroscopy, “G” peak corresponding to the crystal structure and a “D” peak corresponding to the amorphous carbon in the Raman spectrum, and that these peaks shift and/or the FWHM values of these peaks change due to presence of film stress and impurities therein. Thus, the present inventor conducted experiments to find optimum DLC film or optimum amorphous carbon film.

According to the experiments, the DLC film and the amorphous carbon film should have in the Raman spectrum thereof:

(1) at least one peak between wave numbers of 1500 and 1630 cm⁻¹, and the FWHM value of this peak should be 150 cm⁻¹ or above;

(2) a single peak between wave numbers of 800 and 1900 cm⁻¹, i.e., the Raman spectrum should have a single point of inflexion in this wave number range, although a minor change due to an error or noise in the measurement is not considered a point of inflexion; or

(3) at least one peak between wave numbers of 1250 and 1350 cm⁻¹ and at least one peak between wave numbers of 1400 and 1500 cm⁻¹.

More specifically, if one of the above three conditions is satisfied in the Raman spectrum measured for the DLC film or the amorphous carbon film, the DLC film or the amorphous film can be preferably used for manufacturing the anode of the present invention. Typical Raman spectrums defined in the above three conditions (1), (2) and (3) are exemplified in FIGS. 14 to 16, respectively.

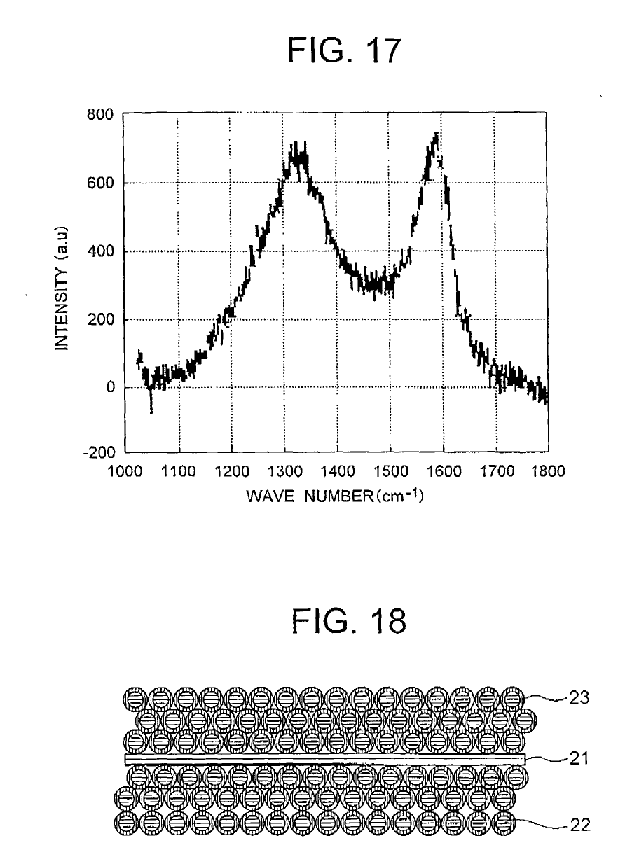

FIG. 17 shows a typical Raman spectrum of a DLC film or an amorphous carbon film in an anode of a tenth comparative example, which does not satisfy either of the above three conditions and thus resides outside the scope of the DLC overcoat for the anode of the present invention, The DLC film of the comparative example has a peak between the wave numbers of 1500 and 1630 cm−1; however, the FWHM value is about 100 cm−1.

Table 9 shows the results of the cycle tests conducted for the tenth samples and the tenth comparative examples, showing current-storage capacity after 300 cycles for each of the secondary batteries including DLC films having Raman spectrums shown in FIGS. 14 to 17.

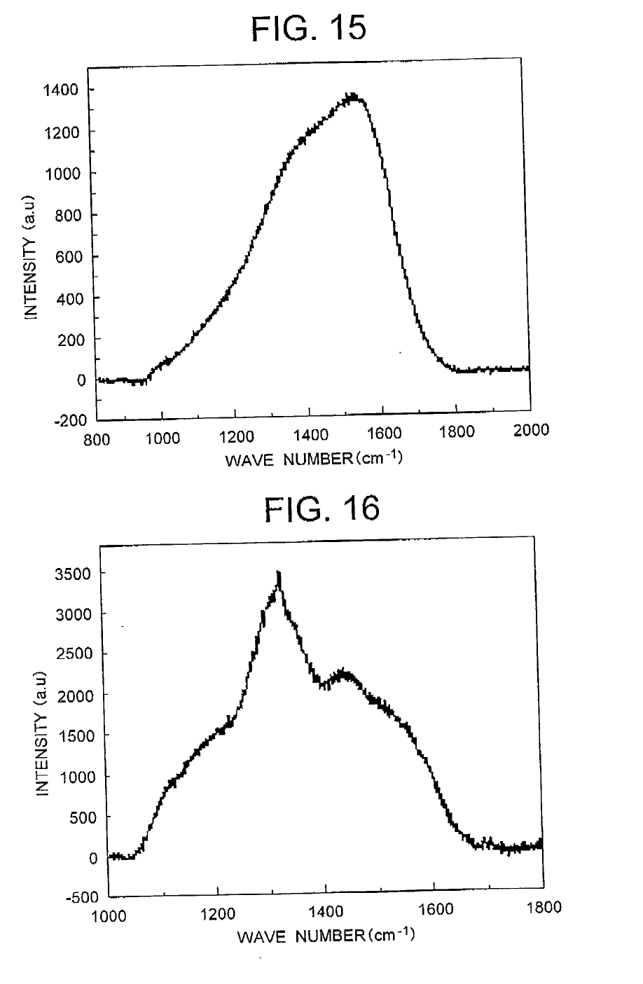

TABLE 9

| | Example 10 | Example 10 | Example 10 | Comp. Ex. 10 |
|---|---|---|---|---|
| | (FIG. 14) | (FIG. 15) | (FIG. 16) | (FIG. 17) |
| Capacity | 92% | 91% | 92% | 86% |

As understood from Table 9, the anode of the example 10 having an overcoat of the DLC film or amorphous carbon film satisfying one of the above three conditions improves the current-storage capacity by about 8% over the comparative example 10 having an overcoat of the DLC film outside the conditions.

Referring to FIG. 18, an anode according to a second embodiment of the present invention, for use in a non-aqueous-electrolyte secondary battery, includes a collector 21, an active material film 22 formed on each of both the surfaces of the collector 21 as a powder layer including powder particles, and an overcoat 23 covering the surfaces of the powder particles of the active material.

The collector 21 is made of metallic foil having electric conductivity, such as aluminum, copper, stainless steel, gold, tungsten, molybdenum, and titanium. The active material 22 film may be made of lithium alloy, lithium-occluding metal, lithium-occluding alloy, metallic oxide, graphite, fullerene, carbon nano-tube powder, or a mixture thereof. The overcoat 23 covers the surface of each of the powdery particles of the active material in this embodiment, and is made of DLC or amorphous carbon.

In operation of a non-aqueous-electrolyte secondary battery having the anode according to the second embodiment, the anode receives lithium ions from the cathode via the electrolyte. In this step, the lithium ions first passes the overcoat 13, then is occluded by the active material film 12. The charge operation is finished when substantially all of the lithium ions are occluded. After the charge operation, the active material film 22 expands to increase its volume due to the occlusion. On the other hand, in a discharge operation, the active material film 22 releases the lithium ions thus occluded during the charge operation, and shrinks to reduce its volume. The lithium ions released by the active material film 22 pass the overcoat 23 to move toward the cathode via the electrolyte. Some of the lithium ions stay within the overcoat 23 during the charge operation, and the some of the lithium ions move toward the cathode during the next discharge operation.

In these charge and discharge cycle, the overcoat 23, which is chemically stable and has a high degree of hardness, suppresses growth of dendrite or degradation of the materials for the anode caused by the electrolyte. In addition, the overcoat 23 is scarcely damaged by the cubic expansion and shrinkage of the active material film 22, and exists on the active material film 22 with stability.

Eleventh samples of the anode according to a second embodiment of the present invention were manufactured, wherein the collector 21 was made of 10-μm-thick copper foil, and the active material film 22 was made of a 100-μm-thick graphite. The graphite was either natural graphite, artificial graphite or hard carbon powder having grain sizes of 10 to 50 μm. A 5-nm-thick DLC film 23 was formed on each surface of the grains of the powder. Secondary batteries having the eleventh samples of the anode were subjected to similar cycle tests, which were compared to those of the second comparative example, The results are shown in Table 10.

TABLE 10

| Active material | Artificial graphite | Natural graphite | Hard carbon |
|---|---|---|---|
| Sample 11 | 87% | 87% | 87% |
| Comp. Ex. 2 | 83% | 83% | 81% |

As understood from Table 10, eleventh samples of the anode improved current-storage capacity by about 5% over the second comparative examples after 300 cycles.

Twelfth samples of the anode according to the second embodiment were manufactured, wherein the collector 21 was made of 18-μm-thick copper foil, and the active material film 22 was made of a 15-μm-thick lithium-occluding metal, which was either Si, Al or Sn. The lithium occluding metal had an average grain size of 5 μm. A 20-nm-thick DLC film 23 was formed on each surface of the grains of the lithium-occluding metal. Secondary batteries having the twelfth samples of the anode were subjected to similar cycle tests, which were compared to those of the third comparative examples. The results are shown in Table 11.

TABLE 11

| Active material | Natural graphite | Artificial graphite | Hard carbon |
|---|---|---|---|
| Sample 12 | 86% | 84% | 83% |
| Comp. Ex. 3 | 75% | 75% | 73% |

As understood from Table 11, twelfth samples of the anode improved current-storage capacity by about 10% over the third comparative examples, as measured after 300 cycles.

Thirteenth samples of the anode according to the second embodiment were manufactured, wherein the collector 21 was made of 18-μm-thick copper foil, and the active material film 22 was made of a 10-μm-thick lithium-occluding alloy, which was either LiAl, Lisi or LiSn. The lithium occluding alloy had an average grain size of 3 μm. A 30-nm-thick DLC film 23 was deposited on each surface of the grains of the lithium-occluding alloy by evaporation. Secondary batteries having the thirteenth samples of the anode were subjected to similar cycle tests, which were compared to those of the fourth comparative examples. The results are shown in Table 12.

TABLE 12

| Active material | LiAl | LiSi | LiSn |
|---|---|---|---|
| Sample 13 | 86% | 87% | 89% |
| Comp. Ex. 4 | 72% | 72% | 74% |

As understood from Table 12, thirteenth samples of the anode improved current-storage capacity by about 15% over the fourth comparative examples, as measured after 300 cycles.

Fourteenth samples of the anode according to the second embodiment were manufactured, wherein the collector 21 was made of 15-μm-thick copper foil, and the active material film 22 was made of a 40-μm-thick lithium-occluding metallic oxide, which was either SiOx or SnOx (0<x≦2). The lithium occluding metallic oxide had an average grain size of 8 μm. A 30-nm-thick DLC film 23 was deposited on each surface of the grain of the lithium-occluding metallic oxide by CVD. Secondary batteries having the fourteenth samples of the anode were subjected to similar cycle tests, which were compared to those of the fifth comparative examples. The results are shown in Table 13.

TABLE 13

| Active material | SiOx(0 < x ≦ 2) | SnOx(0 < x ≦ 2) |
|---|---|---|
| Sample 14 | 84% | 82% |
| Comp. Ex. 5 | 61% | 59% |

As understood from Table 13, fourteenth samples of the anode improved current-storage capacity by about 23% over the comparative examples 5, as measured after 300 cycles.

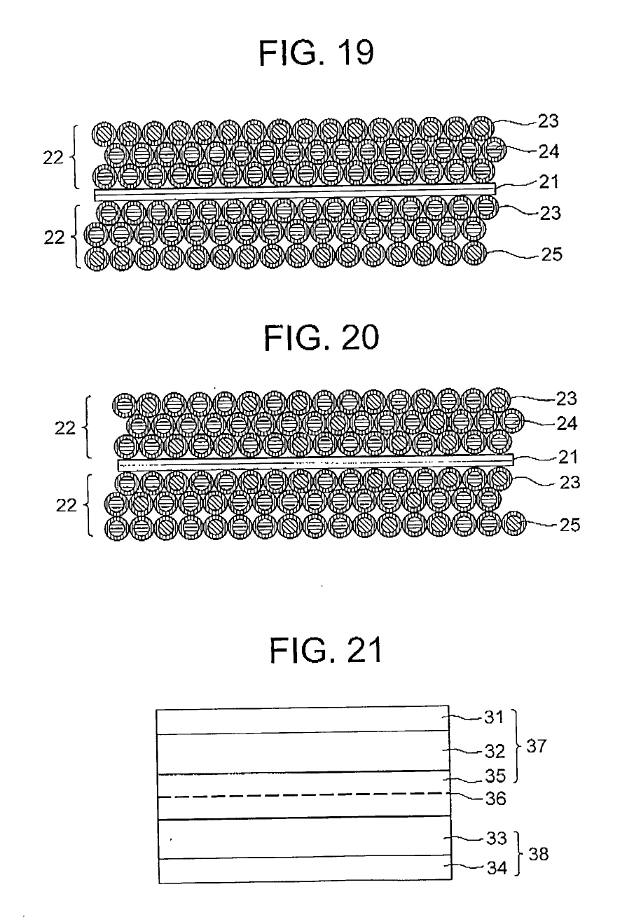

FIG. 19 shows a modification of the anode according to the second embodiment. Fifteenth samples were manufactured according to the modification, wherein the collector 21 was made of 10-μm-thick copper foil, the active material film 24 formed on the top surface of the collector 21 was a 80-μm-thick graphite film 24 and the active material film 25 formed on the bottom surface of the collector 21 was a lithium-occluding material film, which was made of either Si, Sn, Al, LiAl, LiSi, LiSn, SiOx or SnOx (0<x≦2). The graphite had an average grain size of 30 μm. The lithium-occluding material had an average grain size of 2 μm. A 10-nm-thick DLC film 23 was deposited on each of the grains of the graphite film 24 and the lithium-occluding material film 25 by CVD. Secondary batteries having the fifteenth samples of the anode were subjected to similar cycle tests, which were compared to those of the sixth comparative examples. The results are shown in Table 14, wherein 0<x≦2.

TABLE 14

| Li-occl. layer | Si | Sn | Al | LiAl | LiSi | LiSn | SiOx | SnOx |
|---|---|---|---|---|---|---|---|---|
| Sample 15 | 88% | 86% | 84% | 88% | 85% | 89% | 80% | 84% |
| Comp. Ex. 6 | 78% | 77% | 76% | 76% | 76% | 78% | 72% | 72% |

As understood from Table 14, fifteenth samples of the anode improved current-storage capacity by about 12% over the sixth comparative examples, as measured after 300 cycles.

FIG. 20 shows another modification of the anode according to the second embodiment. Sixteenth samples were manufactured according to the another modification, wherein the collector 21 was made of 12-μm-thick copper foil, and the active material film included a 90-μm-thick graphite layer including graphite particles 24 and a 5-μm-thick lithium-occluding material layer including lithium-occluding particles 25 made of Si, Sn, Al, SiOx or SnOx (0<x≦2) and formed on the graphite layer. The graphite had an average grain size of 30 μm, The lithium-occluding material had an average grain size of 2 μm. A 10-nm-thick DLC film 23 was deposited on the graphite particles and the lithium-occluding material particles by sputtering. Secondary batteries having the fifteenth samples of the anode were subjected to similar cycle tests, which were compared to those of the eighth comparative examples. The results are shown in Table 15.

TABLE 15

| Li-occl. layer | Si | Sn | Al | SiOx | SnOx |
|---|---|---|---|---|---|
| Sample 15 | 89% | 88% | 87% | 85% | 84% |
| Comp. Ex. 8 | 78% | 78% | 75% | 76% | 74% |

As understood from Table 15, sixteenth samples of the anode improved current-storage capacity by about 12% over the eighth comparative examples, as measured after 300 cycles.

As described above, the DLC film or the amorphous carbon film covering the surface of the active material for the anode suppresses the growth of dendrite and degradation of the anode, thereby improving cycle lifetime of the secondary battery including the anode.

The DLC film or the amorphous carbon film has a high degree of hardness and strong bonds between molecules, thereby having a higher resistance against decomposition or damage caused by the volume expansion and/or shrinkage due to the charge and discharge cycle of the secondary battery.

Since the above embodiments are described only for examples, the present invention is not limited to the above embodiments and various modifications or alterations can be easily made therefrom by those skilled in the art without departing from the scope of the present invention.

What is claimed is:

1. A anode for use in a secondary battery comprising an active material for occluding and releasing lithium ions, and a diamond-like carbon (DLC) film covering at least a portion of a surface of said active material.

2. The anode as defined in claim 1, wherein said DLC film satisfies either of conditions that a Raman spectrum of said DLC film has:
at least one peak between wave numbers of 1500 and 1630 cm⁻¹, said at least one peak having a full width half maximum (FWHM) value of 150 cm⁻¹ or above;
a single peak between wave numbers 800 and 1900 cm⁻¹; and
at leas one peak between wave numbers of 1250 and 1350 cm⁻¹ and at least one peak between 1400 and 1500 cm⁻¹.

3. The anode as defined in claim 1, wherein said active material includes Si or Sn.

4. The anode as defined in claim 3, wherein said active material includes at least one material selected from the group consisting of Si, Sn and an oxide of Si or Sn.

5. The anode as defined in claim 1, wherein said active material includes at least one material selected from the group consisting of Liₓ LiAl, LiSi and LiSn.

6. The anode as defined in claim 1, wherein said active material is formed as an active material film including at least one layer selected from the group consisting of: a layer including carbon as a main component thereof; a layer including a metallic Si or Sn; a layer including SiOₓ (0<x≦2) or SnO_{y} (0<y≦2); and a layer including Li, LiAl, LiSi or LiSn, and wherein said DLC film covers said active material film.

7. The anode as defined in claim 1, wherein said active material is formed as an active material film wherein lithium-occluding particles are dispersed in carbon, and wherein said DLC film covers said active material film.

8. A secondary battery comprising: the anode as defined in claim 1; a cathode including an active material for releasing and occluding said lithium ions; and an electrolyte disposed between said anode and said cathode for transferring said lithium ions.

9. A anode for use in a secondary battery comprising an active material for occluding and releasing lithium ions, said active material being powdery particles each covered by an amorphous carbon film.

10. The anode as defined in claim 9, wherein said active material includes Si or Sn.

11. The anode as defined in claim 10, wherein said active material includes at least one material selected from the group consisting of Si, Sn and an oxide of Si or Sn.

12. The anode as defined in claim 9, wherein said active material includes at least one material selected from the group consisting of Li, LiAl, LiSi and LiSn.

13. A anode for use in a secondary battery comprising an active material film including Li, Si or Sn, and an amorphous carbon film covering at least a portion of a surface of said active material film.

14. The anode as defined in claim 13, wherein said active material film includes at least one layer selected from the group consisting of: a layer including metallic Si or Sn; a layer including SiOx (0<x≦2) or SnOy (0<y≦2); and a layer including Li, LiAl, LiSi or LiSn.

15. The anode as defined in claim 13, wherein said active material film is such that lithium-occluding particles are dispersed in carbon.

16. The anode as defined in claim 9, wherein said amorphous carbon film is a diamond-like carbon film.

17. A secondary battery comprising: the anode as defined in claim 9; a cathode including another active material for releasing and occluding said lithium ions; and an electrolyte disposed between said anode and said cathode for transferring therethrough said lithium ions.
